(19) United States
(12) Patent Application Publication
(10) Pub. No.: US 2020/0346417 A1
(43) Pub. Date: Nov. 5, 2020

(54) MULTICELLULAR STRUCTURE COMPRISING INTERCONNECTED CELLS

(71) Applicant: 3M INNOVATIVE PROPERTIES COMPANY, Saint Paul, MN (US)

(72) Inventors: Eike H. KLÜNKER, Kaarst (DE); Jeffrey P. KALISH, St. Paul, MN (US); James M. JONZA, Lake Elmo, MN (US)

(21) Appl. No.: 16/763,100

(22) PCT Filed: Nov. 9, 2018
(86) PCT No.: PCT/IB2018/058832

§ 371 Date: May 11, 2020

(30) Foreign Application Priority Data
Nov. 17, 2017 (EP) 17202401.0

(51) Int. Cl. B29C 67/24; B29C 67/20

(52) U.S. Cl. CPC B29C 67/246; B29L 2031/608; B29C 67/20

(57) ABSTRACT

The present disclosure relates to a process of manufacturing a multicellular structure comprising interconnected cells, wherein the process comprises: a) providing a polymerizable precursor of a polymeric material, wherein the polymerizable precursor comprises a reactive monomer mixture; b) providing a mold comprising precursor structures of the multicellular structure; c) optionally, heating at least one the reactive monomer mixture or the mold; d) incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section; e) polymerizing the polymerizable precursor of the polymeric material into the precursor structures of the mold; and f) demolding the multicellular structure formed by polymerizing the polymerizable precursor of the polymeric material. According to another aspect, the present disclosure relates to a multicellular structure obtainable by the process as described above. In another aspect, the present disclosure relates to the use of a multicellular structure as described above for industrial applications.

### TECHNICAL FIELD

The present disclosure relates generally to the field of multicellular structures comprising interconnected cells and sandwich composite articles comprising the same. The present disclosure also relates to a method of manufacturing such multicellular structures, and uses thereof.

### BACKGROUND

Multicellular structures and articles, in particular composite sandwich panels comprising a honeycomb core have been used for a variety of packaging, holding, protecting, supporting, containing, engineering, and dampening purposes. These structures are generally characterized by high strength at low density, and are widely used in many industries, including transportation and construction industries, as well as in the packaging industries. The multicellular structures and articles may be manufactured by using a variety of different materials, depending on the intended application and required characteristics, whereby the materials include paper, carton, polymeric materials, fiber reinforced plastics, composite materials and metals, in particular aluminum.

Multicellular structures and articles made of polymeric materials (for example of at least one of thermoplastic or thermoset materials) are particularly suitable for those applications requiring lightweight characteristics. A suitable method of manufacturing polymer-based multicellular structures utilizes high-pressure extrusion replication from polymer melts.

Common extrusion replication processes to produce multicellular structures are described, for example in U.S. Pat. No. 3,141,913 (Edwards) and U.S. Pat. No. 3,439,798 (James), Great Britain Pat. Doc. No. GB 1 325 017 (Noguchi) and U.S. Pat. Pub. No. 2009/0226698 (De Maria). These processes generally involve the use of a shaping/molding roll and a smooth roll, wherein the shaping/molding roll comprises, on its surface, precursor structures of the multicellular structure to be obtained, and whereby the shaping is performed by allowing the smooth roll to press an extruded layer of the polymer melt onto the molding roll so as to allow the polymer melt to be incorporated into the precursor structures of the multicellular structure provided in the molding roll. However, due to the high viscosity of the polymer melt used in the extrusion replication process, the penetration depth of the melt into the precursor structures of the multicellular structure, thus, the replication depth of the multicellular structure is limited. For the same reasons, the multicellular structures having very thin walls may not be produced by extrusion replication process. Typically, multicellular structures having fine structures, such as a cell wall height of greater than 20 mm coupled with a cell wall thickness of no greater than 2.0 mm, would not be achievable by conventional extrusion replication process. In addition, common extrusion replication processes require the application of high-pressure to facilitate the incorporation of the polymer melt into the precursor structures of the multicellular structure, which necessarily result in increased complexity and additional costs.

Without contesting the technical advantages associated with the method of manufacturing multicellular structures known in the art, there is still a need for a convenient and cost-effective method for producing multicellular structures comprising interconnected cells, which results in multicellular structures provided with improved mechanical performance and characteristics, in particular increased stiffness and reduced density.

### SUMMARY

According to one aspect, the present disclosure relates to a process of manufacturing a multicellular structure comprising interconnected cells, wherein the process comprises:
a) providing a polymerizable precursor of a polymeric material, wherein the polymerizable precursor comprises a reactive monomer mixture;
b) providing a mold comprising precursor structures of the multicellular structure; optionally, heating at least one of the reactive monomer mixture or the mold);
c) incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section;
d) polymerizing the polymerizable precursor of the polymeric material into the precursor structures of the mold; and
e) demolding the multicellular structure formed by polymerizing the polymerizable precursor of the polymeric material.

According to another aspect, the present disclosure relates to a multicellular structure obtainable by the process as described above.

According to still another aspect, the present disclosure relates to a multicellular structure comprising a plurality of interconnected cells having at least one polygonal shape, each cell having cell walls, wherein none of the cell walls comprise a combination of layers, wherein each cell wall has a thickness, wherein the wall thicknesses are no greater than 0.5 mm, wherein each cell wall has a height, and wherein for each cell wall, the cell height to the cell wall thickness aspect-ratio is greater than 15:1.

In yet another aspect, the present disclosure relates to a sandwich composite comprising the multicellular structure as described above.

According to still another aspect, the present disclosure relates to the use of a multicellular structure or a sandwich composite as described above for industrial applications. In yet another aspect, the present disclosure relates to the use of a multicellular structure or a sandwich composite as described above for home and office improvement applications and for personal safety applications.

### DETAILED DESCRIPTION

According to one aspect, the present disclosure relates to a process of manufacturing a multicellular structure comprising interconnected cells, wherein the process comprises:
a) providing a polymerizable precursor of a polymeric material, wherein the polymerizable precursor comprises a reactive monomer mixture;
b) providing a mold comprising precursor structures of the multicellular structure; optionally, heating at least one of the reactive monomer mixture or the mold);
c) incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section;
d) polymerizing the polymerizable precursor of the polymeric material into the precursor structures of the mold; and
e) demolding the multicellular structure formed by polymerizing the polymerizable precursor of a polymeric material.

Surprisingly, the process as described above, in particular, the step of incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section, allows the manufacturing of multicellular structures comprising interconnected cells having fine structures, such as those having typically a cell wall height of greater than 20 mm coupled with a cell wall thickness of no greater than 2.0 mm.

Multicellular structures obtainable by the process as described above, and having fine structures are provided with improved mechanical performance and characteristics such as e.g. increased stiffness and reduced density, when compared to multicellular structures not provided with fine structures.

Without wishing to be bound by theory, it is believed that this ability is due to the outstanding wetting and penetration characteristics provided by the polymerizable precursor of the polymeric material comprising a reactive monomer mixture having a viscosity of no greater than 10,000 mPa-s when incorporated into the precursor structures of the multicellular structure and when measured according to the viscosity test method defined in the experimental section, and which allows the polymerizable precursor of the polymeric material to substantially fill-up the precursor structures of the mold before the polymerizing step of the polymerizable precursor of a polymeric material into the precursor structures of the mold. Advantageously, these excellent wetting and penetration characteristics are provided without the need to apply pressure on the polymerizable precursor to ensure good penetration into the precursor structures of the multicellular structure. In a beneficial aspect of the disclosure, the reactive monomer mixture may substantially fill up the precursor structures of the mold at atmospheric pressure.

The multicellular structures of the present disclosure are particularly suitable for various, including industrial applications, home and office improvement applications and for personal safety applications.

In the context of the present disclosure, the expression “precursor structures of the multicellular structure” is meant to refer to the structures present in the mold, in the form of grooves, channels, recesses, holes, niches, perforations, indentations and any combinations thereof, which replicate the structure and shape of the structures of the multicellular structure to be obtained. In other words, the precursor structures of the multicellular structure, when appropriately filled up with the polymerizable precursor of the polymeric material, will allow forming the desired multicellular structure after suitable polymerization of the polymerizable precursor of the polymeric material into the precursor structures of the mold and appropriate demolding of the multicellular structure formed in the earlier step.

In the context of the present disclosure still, the expression “substantially filling up the precursor structures of the mold” is meant to express that the volume occupied by the precursor structures is filled up with the polymerizable precursor of the polymeric material at least at 80% (in some embodiments, at least at 85%, at least at 90%, at least at 95%, or even at least at 98%) by volume of the precursor structures.

Any multicellular structures comprising interconnected cells may be used in the context of the present disclosure. Suitable multicellular structures comprising interconnected cells for use herein are commonly known in the art and will be easily identified by those skilled in the art, in the light of the present description. In the same manner, the corresponding molds comprising precursor structures of the multicellular structures will also be easily identified by those skilled in the art, in the light of the present description.

Suitable multicellular structures for use herein typically take the form of a cell layer having a first major surface and a second major surface opposite the first major surface, and wherein the cell layer includes an array of cells interconnected with each other. Each of the cells includes at least three cell walls extending between the first and second major surfaces thereof. Some or all cell walls may be shared by the adjacent cells. Each cell is provided with a cell wall thickness and a cell wall height, as commonly known in the art.

As will be easily apparent to those skilled in the art, the cells may have a variety of shapes including triangles, squares, rectangles, pentagons, hexagons, heptagons, octagons, polygons, and any combinations thereof. Moreover, the number of walls shared by adjacent interconnected cells may be varied depending on the desired pattern and ultimate structure.

According to a preferred aspect, the multicellular structure for use herein has an aspect-ratio (cell wall height to cell wall thickness) of greater than 5:1, greater than 10:1, greater than 15:1, greater than 20:1, greater than 25:1, or even greater than 30:1.

In another preferred aspect, the multicellular structure for use herein has a cell wall height of greater than 5 mm, greater than 8 mm, greater than 10 mm, greater than 15 mm, greater than 20 mm, greater than 25 mm, or even greater than 30 mm.

In still another preferred aspect, the multicellular structure for use herein has a cell wall height in a range from 0.5 to 40 mm, from 1 to 35 mm, from 2 to 30 mm, from 3 to 30 mm, from 5 to 25 mm, from 10 to 25 mm, from 15 to 25 mm, or even from 20 to 30 mm.

In yet another preferred aspect, the multicellular structure for use herein has a cell wall thickness of no greater than 2.5 mm, no greater than 2.0 mm, no greater than 1.5 mm, no greater than 1.0 mm, no greater than 0.5 mm, no greater than 0.2 mm, no greater than 0.1 mm, no greater than 0.05 mm, or even no greater than 0.02 mm.

In yet another preferred aspect of the present disclosure, the multicellular structure for use herein has a cell wall thickness in a range from 0.005 to 2.5 mm, from 0.02 to 2.0 mm, from 0.05 to 1.5 mm, from 0.05 to 1.0 mm, or even from 0.1 to 0.5 mm.

According to an advantageous execution, the multicellular structure for use herein is a honeycomb structure. Preferably, the honeycomb structure comprises interconnected cells having a shape selected from the group of hexagons, squares, triangles, and any combinations thereof. More preferably, the honeycomb structure comprises interconnected cells having a hexagonal shape.

The process of manufacturing a multicellular structure comprising interconnected cells according to the present disclosure comprises the step of incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section.

In one preferred aspect of the process according to the present disclosure, the reactive monomer mixture for use herein has a viscosity of no greater than 9,000 mPa-s, no greater than 8,000 mPa-s, no greater than 7,000 mPa-s, no greater than 6,000 mPa-s, no greater than 6,500 mPa-s, no greater than 6,000 mPa-s, no greater than 5,500 mPa-s, no greater than 5,000 mPa-s, no greater than 4,000 mPa-s, no greater than 3,500 mPa-s, no greater than 3,000 mPa-s, no greater than 2,500 mPa-s, no greater than 2,000 mPa-s, or even no greater than 1,500 mPa-s, when measured according to the viscosity test method defined in the experimental section.

In another preferred aspect of the process according to the present disclosure, the reactive monomer mixture for use herein has a viscosity of no greater than 1,300 mPa-s, no greater than 1,000 mPa-s, no greater than 800 mPa-s, no greater than 600 mPa-s, no greater than 500 mPa-s, no greater than 300 mPa-s, no greater than 200 mPa-s, no greater than 150 mPa-s, no greater than 100 mPa-s, no greater than 80 mPa-s, no greater than 50 mPa-s, no greater than 30 mPa-s, no greater than 20 mPa-s, or even no greater than 10 mPa-s, when measured according to the viscosity test method defined in the experimental section.

Any polymerizable precursor of a polymeric material comprising a reactive monomer mixture may be used in the context of the present disclosure, provided they comply with the above-described viscosity requirement. Suitable polymerizable precursors of a polymeric material comprising a reactive monomer mixture for use herein will be easily identified by those skilled in the art, in the light of the present description. Appropriate reactive monomer mixtures and the corresponding polymerizable precursors of a polymeric material may be conveniently selected depending on the desired application and technical performance of the resulting multicellular structure.

According to a typical aspect of the process of the present disclosure, the monomers of the reactive monomer mixture are selected from the group consisting of lactams, lactones, polyisocyanates, polyols, cycloolefin monomers, acrylates, polyamines, polycarboxylic acids, epoxides, and any combinations or mixtures thereof.

In a preferred aspect of the process of the present disclosure, the monomers of the reactive monomer mixture are selected from the group consisting of lactams, lactones, isocyanates, polyols, polyamines, and any combinations or mixtures thereof. More preferably, the monomers of the reactive monomer mixture are selected from the group consisting of lactams, in particular caprolactams, laurolactams, and any combinations or mixtures thereof. Even more preferably, the monomers of the reactive monomer mixture are selected from the group consisting of caprolactams, in particular epsilon-caprolactam.

According to another typical aspect of the process of the present disclosure, the monomers of the reactive monomer mixture are selected from the group consisting of polyisocyanates, polyols, polyamines, and any combinations or mixtures thereof.

Polymeric materials for use herein are not particularly limited, as long as the polymerizable precursor of the polymeric material comprises a reactive monomer mixture meeting the above-described viscosity requirement when incorporated into the precursor structures of the multicellular structure.

According to a typical aspect, the polymeric material for use herein is selected from the group consisting of polymeric elastomers, thermoplastic polymers, thermoplastic elastomers, thermoset polymers, thermoset elastomers, and any combinations or mixtures thereof.

In a preferred aspect, the polymeric material for use herein is selected from the group consisting of polyamides, polyurethanes, polyureas, polyesters, polyolefins, polyacrylates, any combinations or mixtures thereof.

In a more preferred aspect, the polymeric material is selected from the group consisting of polyamides, polyurethanes, polyureas, and any combinations or mixtures thereof.

According to a preferred aspect, the polymeric material for use herein is selected from the group consisting of polyamides, any combinations or mixtures thereof. More preferably, the polymeric material for use herein is a polyamide which is e.g., at least one of polyamide 6, polyamide 12, polyamide 66, polyamide 612, or polyamide 46.

According to an advantageous aspect of the process according to the present disclosure, the reactive monomer mixture and/or the mold may be appropriately heated so as to prepare the reactive monomer mixture for the subsequent polymerization of the polymerizable precursor of a polymeric material into the precursor structures of the mold. The optional heating step will ensure in particular appropriate melting and heating of the reactive ingredients of the reactive monomer mixture before the polymerization step. Suitable heating temperatures may be appropriately chosen based on the starting reactive monomer mixture. In some aspects of the disclosure, the optional heating step may also initiate and/or accelerate the polymerization reaction of the polymerizable precursor of the polymeric material into the precursor structures of the mold.

The process of manufacturing a multicellular structure comprising interconnected cells according to the present disclosure further comprises incorporating the reactive monomer mixture into the precursor structures of the multicellular structure thereby substantially filling up the precursor structures of the mold. This further processing may be performed, for example, according to any technique known in the art.

According to an advantageous aspect of the process according to the disclosure, incorporating the reactive monomer mixture into the precursor structures of the multicellular structure thereby substantially filling up the precursor structures of the mold, is performed without applying any additional (external) pressure other than atmospheric pressure (i.e., about 101,300 Pa).

In an exemplary aspect, incorporating the reactive monomer mixture into the precursor structures of the multicellular structure is performed by simply pouring the reactive monomer mixture into the precursor structures of the multicellular structure.

According to a preferred aspect of the process according to the disclosure, incorporating the reactive monomer mixture into the precursor structures of the multicellular structure thereby substantially filling up the precursor structures of the mold, is substantially completed within a period of no greater than 30 seconds, no greater than 25 seconds, no greater than 20 seconds, no greater than 15 seconds, no greater than 10 seconds, or even no greater than 5 seconds.

The process of manufacturing a multicellular structure comprising interconnected cells according to the present disclosure further comprises polymerizing the polymerizable precursor of the polymeric material into the precursor structures of the mold. The polymerization may be performed, for example, according to any technique known in the art. Suitable polymerization conditions, such a reaction temperatures, suitable atmospheres and kinetics, may be appropriately chosen based on the starting reactive monomer mixture and the characteristics of the polymerizable precursor of the polymeric material. The polymerization may be typically performed in an inert atmosphere.

According to a typical aspect, polymerizing the polymerizable precursor of a polymeric material is performed by at least one of thermal polymerization or actinic radiation polymerization.

In an advantageous aspect of the process according to the disclosure, polymerizing the polymerizable precursor of a polymeric material is performed by thermal polymerization.

According to a typical aspect, thermally polymerizing the polymerizable precursor of a polymeric material is performed at a temperature below the softening temperature of the polymeric material.

According to a preferred aspect, polymerizing the polymerizable precursor of a polymeric material is performed by at least one of ring-opening polymerization or polycondensation. In an advantageous execution, the polymerization is performed by ring-opening polymerization. Ring-opening polymerization is particularly suitable for the polymerization of a reactive monomer mixture comprising cyclic monomers (e.g., lactams and lactones), in particular lactams.

The ring-opening polymerization may be beneficially performed by any of ionic polymerization, radical polymerization or metathesis polymerization. In a preferred execution, the step of polymerizing the polymerizable precursor of a polymeric material is performed by ionic, in particular anionic ring-opening polymerization. The anionic ring-opening polymerization is particularly advantageous for the polymerization of a reactive monomer mixture comprising lactams (e.g., at least one of caprolactams or laurolactams).

Depending on the starting monomers of the reactive monomer mixture and the characteristics of the polymerizable precursor of the polymeric material, the polymerizable precursor may, for example, advantageously comprise at least one of polymerization activators or polymerization catalysts. The amount and nature of the polymerization activators and polymerization catalysts for use herein may be tailored depending upon the desired properties of the resulting polymeric material.

According to a preferred aspect of the process according to the disclosure, polymerizing the polymerizable precursor of the polymeric material is substantially completed within a period of no greater than 30 seconds, no greater than 25 seconds, no greater than 20 seconds, no greater than 15 seconds, no greater than 10 seconds, or even no greater than 5 seconds.

The process of manufacturing a multicellular structure comprising interconnected cells according to the present disclosure further comprises demolding the multicellular structure formed by polymerizing the polymerizable precursor of the polymeric material, and present into the precursor structures of the mold.

Demolding may be performed, for example, according to any technique known in the art. Suitable demolding conditions, such a demolding temperatures and suitable tools, may be appropriately chosen based on the starting reactive monomer mixture and the characteristics of the polymeric material formed into the precursor structures of the mold. In some particular aspects, it may be beneficial to use a release coating at the bottom part of the mold so as to facilitate the demolding of the multicellular structure present into the precursor structures of the mold.

According to an advantageous aspect of the process of the disclosure, demolding the multicellular structure may be performed in a range from 20 to 35° C., in particular at 23° C.

According to typical aspect of the process, demolding the multicellular structure may be performed at a temperature below the softening temperature of the polymeric material.

According to another aspect, the present disclosure relates to a multicellular structure obtainable by the process as described above.

All the particular and preferred aspects described above with respect to the multicellular structure in the context of the process of manufacturing a multicellular structure, are herewith fully applicable to the multicellular structure obtainable by such process. These aspects relate in particular to the suitable polymeric material, the aspect-ratio (cell wall height to cell wall thickness), the cell wall height, the cell wall thickness, and the particular constructions of the multicellular structure.

According to an advantageous execution, the multicellular structure obtainable by the process as described above is a honeycomb structure. Preferably, the honeycomb structure comprises interconnected cells having a shape selected from the group of hexagons, squares, triangles, and any combinations thereof. More preferably, the honeycomb structure comprises interconnected cells having a hexagonal shape.

According to still another aspect, the present disclosure relates to a multicellular structure comprising a plurality of interconnected cells having at least one polygonal shape, each cell having cell walls, wherein none of the cell walls comprise a combination of layers, wherein each cell wall has a thickness, wherein the wall thicknesses are no greater than 0.5 mm, wherein each cell wall has a height, and wherein for each cell wall, the cell height to the cell wall thickness aspect-ratio is greater than 15:1.

In an advantageous aspect of the multicellular structure of the present disclosure, the wall thicknesses are no greater than 0.2 mm, no greater than 0.1 mm, no greater than 0.05 mm, or even no greater than 0.02 mm.

In another advantageous aspect of the multicellular structure of the present disclosure, the cell height to the cell wall thickness aspect-ratio is greater than 20:1, greater than 25:1, or even greater than 30:1.

All the particular and preferred aspects described above with respect to the multicellular structure in the context of the process of manufacturing a multicellular structure, are herewith fully applicable to the multicellular structure as described. These aspects relate in particular to the suitable polymeric material, the aspect-ratio (cell wall height to cell wall thickness), the cell wall height, the cell wall thickness, and the particular constructions of the multicellular structure.

According to an advantageous execution, the multicellular structure as described above is a honeycomb structure. Preferably, the honeycomb structure comprises interconnected cells having a shape selected from the group of hexagons, squares, triangles, and any combinations thereof. More preferably, the honeycomb structure comprises interconnected cells having a hexagonal shape.

According to still another aspect, the present disclosure relates to a sandwich composite comprising the multicellular structure as described above. The multicellular structure of the present disclosure may be indeed suitably associated with other appropriate constituting elements and form a sandwich composite. Any commonly known constituting elements of sandwich composites may be used with the multicellular structures of the present disclosure. Exemplary constituting elements include foams, films, adhesives layers, sheets, resin-infused fabrics, fiber-reinforced sheets, and combinations thereof.

In an advantageous aspect, the sandwich composite takes the form of a composite sandwich panel.

The multicellular structure of the present disclosure may be used in a variety of articles and applications, such as for packaging, holding, protecting, supporting, containing, engineering, and dampening purposes. These multicellular structures may be used in many industries, including transportation and construction industries, as well as in the packaging industries. As such, the multicellular structures of the present disclosure are particularly suitable for those applications requiring lightweight characteristics.

Accordingly, the present disclosure is further directed to the use of a multicellular structure or a sandwich composite as described above for industrial applications, in particular for construction and transportation applications.

In one advantageous aspect, the multicellular structure or the sandwich composite of the present disclosure are used for acoustical absorption, in particular in automotive applications.

In another advantageous aspect, the multicellular structure or the sandwich composite of the present disclosure are used for home improvement applications, in particular for decoration and surface protection; and for personal safety applications.

In still another advantageous aspect, the multicellular structure or the sandwich composite of the present disclosure are used for vibration damping and cushioning, in particular in home and office applications; and for fall protection applications.

Item 1 is a process of manufacturing a multicellular structure comprising interconnected cells, wherein the process comprises:

providing a polymerizable precursor of a polymeric material, wherein the polymerizable precursor comprises a reactive monomer mixture;
providing a mold comprising precursor structures of the multicellular structure;
optionally, heating at least one of the reactive monomer mixture or the mold;
incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section;
polymerizing the polymerizable precursor of the polymeric material into the precursor structures of the mold; and
demolding the multicellular structure formed by polymerizing the polymerizable precursor of the polymeric material.

Item 2 is a process according to item 1, wherein the reactive monomer mixture for use herein has a viscosity of no greater than 9,000 mPa-s, no greater than 8,000 mPa-s, no greater than 7,000 mPa-s, no greater than 6,000 mPa-s, no greater than 6,500 mPa-s, no greater than 6,000 mPa-s, no greater than 5,500 mPa-s, no greater than 5,000 mPa-s, no greater than 4,000 mPa-s, no greater than 3,500 mPa-s, no greater than 3,000 mPa-s, no greater than 2,500 mPa-s, no greater than 2,000 mPa-s, or even no greater than 1,500 mPa-s, when measured according to the viscosity test method defined in the experimental section.

Item 3 is a process according to any of item 1 or 2, wherein the reactive monomer mixture has a viscosity of no greater than 1,300 mPa-s, no greater than 1,000 mPa-s, no greater than 800 mPa-s, no greater than 600 mPa-s, no greater than 500 mPa-s, no greater than 300 mPa-s, no greater than 200 mPa-s, no greater than 150 mPa-s, no greater than 100 mPa-s, no greater than 80 mPa-s, no greater than 50 mPa-s, no greater than 30 mPa-s, no greater than 20 mPa-s, or even no greater than 10 mPa-s, when measured according to the viscosity test method defined in the experimental section.

Item 4 is a process according to any of the preceding items, wherein the monomers of the reactive monomer mixture are selected from the group consisting of lactams, lactones, isocyanates, polyols, cycloolefin monomers, acrylates, polyamines, polycarboxylic acids, epoxides, and any combinations or mixtures thereof.

Item 5 is a process according to any of the preceding items, wherein the monomers of the reactive monomer mixture are selected from the group consisting of lactams, lactones, isocyanates, polyols, polyamines and any combinations or mixtures thereof.

Item 6 is a process according to any of the preceding items, wherein the monomers of the reactive monomer mixture are selected from the group consisting of lactams, in particular caprolactams, laurolactams, and any combinations or mixtures thereof.

Item 7 is a process according to any of the preceding items, wherein the monomers of the reactive monomer mixtures are selected from the group consisting of isocyanates, polyols, polyamines, and any combinations or mixtures thereof.

Item 8 is a process according to any of the preceding items, wherein incorporating the reactive monomer mixture into the precursor structures of the multicellular structure thereby substantially filling up the precursor structures of the mold, is substantially completed within a period of no greater than 30 seconds, no greater than 25 seconds, no greater than 20 seconds, no greater than 15 seconds, no greater than 10 seconds, or even no greater than 5 seconds.

Item 9 is a process according to any of the preceding items, wherein incorporating the reactive monomer mixture into the precursor structures of the multicellular structure thereby substantially filling up the precursor structures of the mold, is performed without applying any (external) pressure other than atmospheric pressure (i.e., 101,300 Pa).

Item 10 is a process according to any of the preceding items, wherein polymerizing the polymerizable precursor of the polymeric material is performed by at least one of thermal polymerization or actinic radiation polymerization.

Item 11 is a process according to any of the preceding items, wherein polymerizing the polymerizable precursor of the polymeric material is performed by thermal polymerization, preferably at a temperature below the softening temperature of the polymeric material.

Item 12 is a process according to any of the preceding items, wherein polymerizing the polymerizable precursor of the polymeric material is performed by at least one of ring-opening polymerization or polycondensation.

Item 13 is a process according to item 12, wherein the ring-opening polymerization is performed by at least one of ionic polymerization, radical polymerization or metathesis polymerization.

Item 14 is a process according to any of the preceding items, wherein polymerizing the polymerizable precursor of the polymeric material is performed by ionic, in particular anionic ring-opening polymerization.

Item 15 is a process according to any of the preceding items, wherein the polymerizable precursor further comprises at least one of polymerization activators or polymerization catalysts.

Item 16 is a process according to any of the preceding items, wherein polymerizing the polymerizable precursor of the polymeric material is substantially completed within a period of no greater than 30 seconds, no greater than 25 seconds, no greater than 20 seconds, no greater than 15 seconds, no greater than 10 seconds, or even no greater than 5 seconds.

Item 17 is a process according to any of the preceding items, wherein the polymeric material is selected from the group consisting of polymeric elastomers, thermoplastic polymers, thermoplastic elastomers, thermoset polymers, thermoset elastomers, and any combinations or mixtures thereof.

Item 18 is a process according to any of the preceding items, wherein the polymeric material is selected from the group consisting of polyamides, polyurethanes, polyureas, polyesters, polyolefins, polyacrylates, any combinations or mixtures thereof.

Item 19 is a process according to any of the preceding items, wherein the polymeric material is selected from the group consisting of polyamides, polyurethanes, polyureas, and any combinations or mixtures thereof.

Item 20 is a process according to any of the preceding items, wherein the polymeric material is selected from the group consisting of polyamides, any combinations or mixtures thereof.

Item 21 is a process according to item 20, wherein the polymeric material is a polyamide which is at least one of polyamide 6, polyamide 12, polyamide 66, polyamide 612 or polyamide 46.

Item 22 is a process according to any of the preceding items, wherein demolding the multicellular structure is performed at a temperature in a range from 20 to 35° C., in particular at 23° C.

Item 23 is a process according to any of the preceding items, wherein demolding the multicellular structure is performed at a temperature below the softening temperature of the polymeric material.

Item 24 is a process according to any of the preceding items, wherein the multicellular structure has an aspect-ratio (cell wall height to cell wall thickness) of greater than 5:1, greater than 10:1, greater than 15:1, greater than 20:1, greater than 25:1, or even greater than 30:1.

Item 25 is a process according to any of the preceding items, wherein the multicellular structure has a cell wall height of greater than 5 mm, greater than 8 mm, greater than 10 mm, greater than 15 mm, greater than 20 mm, greater than 25 mm, or even greater than 30 mm.

Item 26 is a process according to any of the preceding items, wherein the multicellular structure has a cell wall height comprised from 0.5 to 40 mm, from 1 to 35 mm, from 2 to 30 mm, from 3 to 30 mm, from 5 to 25 mm, from 10 to 25 mm, from 15 to 25 mm, or even from 20 to 30 mm.

Item 27 is a process according to any of the preceding items, wherein the multicellular structure has a cell wall thickness of no greater than 2.5 mm, no greater than 2.0 mm, no greater than 1.5 mm, no greater than 1.0 mm, no greater than 0.5 mm, no greater than 0.2 mm, no greater than 0.1 mm, no greater than 0.05 mm, or even no greater than 0.02 mm.

Item 28 is a process according to any of the preceding items, wherein the multicellular structure has a cell wall thickness in a range from 0.005 to 2.5 mm, from 0.02 to 2.0 mm, from 0.05 to 1.5 mm, from 0.05 to 1.0 mm, or even from 0.1 to 0.5 mm.

Item 29 is a process according to any of the preceding items, wherein the multicellular structure is a honeycomb structure.

Item 30 is a process according to item 29, wherein the honeycomb structure comprises interconnected cells having a shape selected from the group of hexagons, squares, triangles, and any combinations thereof.

Item 31 is a process according to any of item 29 or 30, wherein the honeycomb structure comprises interconnected cells having a hexagonal shape.

Item 32 is a multicellular structure obtainable by the process according to any of items 1 to 31.

Item 33 is a multicellular structure according to item 32, wherein the polymeric material is selected from the group consisting of polymeric elastomers, thermoplastic polymers, thermoplastic elastomers, thermoset polymers, thermoset elastomers, and any combinations or mixtures thereof.

Item 34 is a multicellular structure according to any of item 32 or 33, wherein the polymeric material is selected from the group consisting of polyamides, polyurethanes, polyureas, polyesters, polyolefins, polyacrylates, any combinations or mixtures thereof.

Item 35 is a multicellular structure according to any of items 32 to 34, wherein the polymeric material is selected from the group consisting of polyamides, polyurethanes, polyureas, and any combinations or mixtures thereof.

Item 36 is a multicellular structure according to any of items 32 to 35, wherein the polymeric material is selected from the group consisting of polyamides, any combinations or mixtures thereof.

Item 37 is a multicellular structure according to item 36, wherein the polymeric material is a polyamide which is at least one of polyamide 6, polyamide 12, polyamide 66, polyamide 612 or polyamide 46.

Item 38 is a multicellular structure according to any of items 32 to 37, which has an aspect-ratio (cell wall height to cell wall thickness) of greater than 5:1, greater than 10:1, greater than 15:1, greater than 20:1, greater than 25:1, or even greater than 30:1.

Item 39 is a multicellular structure according to any of items 32 to 38, which has a cell wall height of greater than 5 mm, greater than 8 mm, greater than 10 mm, greater than 15 mm, greater than 20 mm, greater than 25 mm, or even greater than 30 mm.

Item 40 is a multicellular structure according to any of items 32 to 39, which has a cell wall height comprised from 0.5 to 40 mm, from 1 to 35 mm, from 2 to 30 mm, from 3 to 30 mm, from 5 to 25 mm, from 10 to 25 mm, from 15 to 25 mm, or even from 20 to 30 mm.

Item 41 is a multicellular structure according to any of items 32 to 40, which has a cell wall thickness of no greater than 2.5 mm, no greater than 2.0 mm, no greater than 1.5 mm, no greater than 1.0 mm, no greater than 0.5 mm, no greater than 0.2 mm, no greater than 0.1 mm, no greater than 0.05 mm, or even no greater than 0.02 mm.

Item 42 is a multicellular structure according to any of items 32 to 41, which has a cell wall thickness in a range from 0.005 to 2.5 mm, from 0.02 to 2.0 mm, from 0.05 to 1.5 mm, from 0.05 to 1.0 mm, or even from 0.1 to 0.5 mm.

Item 43 is a multicellular structure comprising a plurality of interconnected cells having at least one polygonal shape, each cell having cell walls, wherein none of the cell walls comprise a combination of layers, wherein each cell wall has a thickness, wherein the wall thicknesses are no greater than 0.5 mm, wherein each cell wall has a height, and wherein for each cell wall, the cell height to the cell wall thickness aspect-ratio is greater than 15:1.

Item 44 is a multicellular structure according to item 43, wherein the wall thicknesses are no greater than 0.2 mm, no greater than 0.1 mm, no greater than 0.05 mm, or even no greater than 0.02 mm.

Item 45 is a multicellular structure according to any of item 43 or 44, wherein the cell height to the cell wall thickness aspect-ratio is greater than 20:1, greater than 25:1, or even greater than 30:1.

Item 46 is a multicellular structure according to any of items 32 to 45, which is a honeycomb structure.

Item 47 is a multicellular structure according to item 46, wherein the honeycomb structure comprises interconnected cells having a shape selected from the group of hexagons, squares, triangles, and any combinations thereof.

Item 48 is a multicellular structure according to any of item 46 or 47, wherein the honeycomb structure comprises interconnected cells having a hexagonal shape.

Item 49 is a sandwich composite comprising a multicellular structure according to any of items 32 to 48.

Item 50 is the use of a multicellular structure according to any of items 32 to 48 or a sandwich composite according to item 49 for industrial applications, in particular for construction and transportation applications.

Item 51 is the use according to item 50 for acoustical absorption, in particular in automotive applications.

Item 52 is the use of a multicellular structure according to any of items 32 to 48 or a sandwich composite according to item 49 for home improvement applications, in particular for decoration and surface protection; and for personal safety applications.

Item 53 is the use according to item 52 for vibration damping and cushioning, in particular in home and office applications; and for fall protection applications.

### EXAMPLES

The present disclosure is further illustrated by the following examples. These examples are merely for illustrative purposes only and are not meant to be limiting on the scope of the appended claims.

### Test Methods Applied:

### Viscosity Test Method:

The viscosity of the reactive monomer mixture is determined according to Test Method DIN EN ISO 3219:1993. The measurements are performed at the suitable temperature with a viscosimeter. The choice of a specific spindle type and suitable rotational speed for the viscosity measurements will depend on the particulars of the reactive monomer mixture and is well within the capabilities of those skilled in the art.

### Raw Materials and Equipment Used:

In the examples, the following raw materials are used:

Epsilon-caprolactam is obtained from Brüggemann Chemical KG, Germany, under the trade designation “AP-NYLON®”.

Epsilon-Caprolactam polymerization catalyst obtained from Brüggemann Chemical KG, Germany, under the trade designation “BRUGGOLEN® C10”.

Epsilon-Caprolactam polymerization activator obtained from Brüggemann Chemical KG, Germany, under the trade designation “BRUGGOLEN® C20P”.

Polyol is obtained from King Industries, Norwalk, Conn., USA, under the trade designation “K-FLEX 188”.

Polyisocyanate obtained from Covestro, Leverkusen, Germany, under the trade designation “DESMODUR N3300”.

Polyurethane polymerization catalyst obtained from Evonik Industries, Essen, Germany, under the trade designation “DABCO T12”.

Hand mold: For performing the process of the present disclosure, it was made use of a lab scale aluminum hand mold having the following dimensions (127 mm×77 mm×9 mm) length-width-thickness) and provided with precursor structures of honeycomb structure comprising hexagonal cells, wherein the largest distance between two opposed walls is of about 10 mm, and wherein the precursor structures have the following dimensions: cell wall height of 7.6 mm and a cell wall thickness of 0.6 mm at the bottom surface of the mold and 1.3 mm at the top surface of the mold (i.e., opposed to the bottom surface of the mold).

### EXAMPLES

### Example 1: Polyamide 6 Multicellular Structure

Preparation of the Reactive Monomer Mixture:

The reactive monomer mixture used in the process of the present and having the composition as shown in Table 1, were prepared as detailed below.

TABLE 1

| Composition | Amount |
|---|---|
| Epsilon-Caprolactam | 93 wt % |
| Epsilon-Caprolactam polymerization | 5 wt % |
| catalyst | |
| Epsilon-Caprolactam polymerization | 2 wt % |
| activator | |

Two glass 250 ml vessels (obtained from Schott AG, Germany) A and B were filled with 69.75 grams of epsilon-caprolactam, representing half of the total amount of epsilon-caprolactam. The epsilon-caprolactam polymerization activator was added to vessel A and the epsilon-caprolactam polymerization catalyst was added to vessel B. Both vessels were placed in an oil bath at 150° C. to melt the ingredients and heat-up the monomer mixture before polymerization. In parallel, the hand mold is placed in an oven at 190° C. to heat-up the mold for the subsequent polymerization step.

Preparation of the Multicellular Structure:

After complete melting of the ingredients placed in vessels A and B, the hand mold was taken out of the oven and placed on a heating plate at 190° C. to maintain the hand mold temperature. The content of vessel A was then added into vessel B in a nitrogen atmosphere and the mixture was stirred manually. The heated reactive monomer mixture was poured manually onto the hand mold with no additional pressure applied and still under nitrogen atmosphere, to allow the reactive monomer mixture to be incorporated into the precursor structures of the multicellular structure thereby substantially filling up the precursor structures of the hand mold. Excellent wetting and penetration into the precursor structures of the hand mold was observed within less than 5 seconds.

The polymerization of the reactive monomer mixture took place immediately when the content of vessel A is added into vessel B and was continued into the precursor structures of the multicellular structure in the hand mold. The polymerization of the reactive monomer mixture into polyamide 6 is substantially completed after about 20 seconds after the heated reactive monomer mixture has been poured onto the hand mold.

After a period of 5 minutes after the heated reactive monomer mixture had been poured onto the hand mold, the hand mold is cooled to room temperature using water. The multicellular structure was then demolded manually from the mold.

The resulting honeycomb multicellular structure had a cell wall height of about 7.6 mm and a cell wall thickness of about 0.6 mm at the surface corresponding to the bottom surface of the mold and about 1.3 mm at the surface corresponding to the top surface of the mold.

### Example 2: Polyurethane Multicellular Structure

Preparation of the Reactive Monomer Mixture:

11.4 grams of the polyol was weighed into a 50-ml disposable beaker (available from Sigma-Aldrich). 9.5 grams of the polyisocyanate was added into the beaker followed by 2 drops of the polyurethane polymerization catalyst.

Preparation of the Multicellular Structure:

The ingredients were mixed by stirring with a tongue depressor for about 30 seconds at ambient room temperature (23° C.+/−2° C., 50% relative humidity+/−5%° C.), then poured onto the honeycomb hand mold. The mixture flowed into the tool and a glass fabric was laid over the mixture which was then left to cure for 30 minutes. After this time, the polyurethane was sufficiently strong to pull out cleanly and manually from the honeycomb tooling roll.

The resulting honeycomb multicellular structure had a cell wall thickness of about 0.6 mm at the surface corresponding to the bottom surface of the mold and about 1.3 mm at the surface corresponding to the top surface of the mold.

1. A process of manufacturing a multicellular structure comprising interconnected cells, wherein the process comprises:
a) providing a polymerizable precursor of a polymeric material, wherein the polymerizable precursor comprises a reactive monomer mixture;
b) providing a mold comprising precursor structures of the multicellular structure;
c) optionally, heating at least one of the reactive monomer mixture or the mold;
d) incorporating the reactive monomer mixture into the precursor structures of the multicellular structure thereby substantially filling up the precursor structures of the mold, wherein the reactive monomer mixture has a viscosity of no greater than 10,000 mPa-s when incorporated into the precursor structures of the multicellular structure and when measured according to the viscosity test method defined in the experimental section;
e) polymerizing the polymerizable precursor of the polymeric material into the precursor structures of the mold; and
f) demolding the multicellular structure formed by polymerizing the polymerizable precursor of the polymeric material.

2. A process according to claim 1, wherein the reactive monomer mixture for use herein has a viscosity of no greater than 1,500 mPa-s, when measured according to the viscosity test method defined in the experimental section.

3. A process according to claim 1, wherein the monomers of the reactive monomer mixture are selected from the group consisting of lactams, lactones, isocyanates, polyols, cycloolefin monomers, acrylates, polyamines, polycarboxylic acids, epoxides, and any combinations or mixtures thereof.

4. A process according to claim 1, wherein the polymeric material is selected from the group consisting of polyamides, polyurethanes, polyureas, polyesters, polyolefins, polyacrylates, any combinations or mixtures thereof.

5. A process according to claim 1, wherein the multicellular structure has a cell wall height of greater than 5 mm.

6. A process according to claim 1, wherein the multicellular structure has a cell wall thickness of no greater than 2.5 mm.

7. A process according to claim 1, wherein the multicellular structure is a honeycomb structure.

8. A multicellular structure obtainable by the process according to claim 1.

9. A multicellular structure according to claim 8, which has a cell wall height of greater than 5 mm.

10. A multicellular structure according to claim 8, which has a cell wall thickness in a range from 0.005 to 2.5 mm.

11. A multicellular structure comprising a plurality of interconnected cells having at least one polygonal shape, each cell having cell walls, wherein none of the cell walls comprise a combination of layers, wherein each cell wall has a thickness, wherein the wall thicknesses are no greater than 0.5 mm, wherein each cell wall has a height, and wherein for each cell wall, the cell height to the cell wall thickness aspect-ratio is greater than 15:1.

12. A multicellular structure according to claim 11, wherein the wall thicknesses are no greater than 0.2 mm.

13. A multicellular structure according to claim 8, which is a honeycomb structure.

14. A sandwich composite comprising the multicellular structure according to claim 8.

15. A method of using the multicellular structure according to claim 8 or a sandwich composite according to claim 14 for construction and transportation applications.
